(19) United States
(12) Patent Application Publication
(10) Pub. No.: US 2013/0048094 A1
(43) Pub. Date: Feb. 28, 2013

(54) CONTINUOUS ADDITIVE PROPORTIONING

(71) Applicant: William MacKay Ballantyne, Eden Prairie, MN (US)

(72) Inventor: William MacKay Ballantyne, Eden Prairie, MN (US)

(73) Assignee: Cobra North America, LLC dba Pyrolance North America, Centennial, CO (US)

(21) Appl. No.: 13/592,993

(22) Filed: Aug. 23, 2012

Related U.S. Application Data
(60) Provisional application No. 61/526,545, filed on Aug. 23, 2011.

(51) Int. Cl. G05D 11/00

(52) U.S. Cl. 137/3; 137/115.11

(57) ABSTRACT

The presently disclosed technology provides a venturi injector having a motive fluid inlet and a suction fluid inlet that mixes the motive fluid and the suction fluid at a desired mixing ratio over a variety of motive fluid flow rates. A pressure feedback loop fluidly links the motive fluid pressure at the motive fluid inlet of the venturi injector with the suction fluid pressure at the suction fluid inlet of the venturi injector.

### CROSS-REFERENCE TO RELATED APPLICATIONS

The present application claims benefit of priority to U.S. Provisional Patent Application No. 61/526,545, entitled “Continuous Water Additive Proportioning,” and filed on 23 Aug. 2011; which is specifically incorporated by reference herein for all that it discloses or teaches. The present application is further related to International Patent Application No. PCT/US2012/______, entitled “Continuous Additive Proportioning” and filed on 23 Aug. 2012, which is also specifically incorporated by reference herein for all that it discloses or teaches.

### BACKGROUND

Various water additives are frequently utilized in firefighting operations to improve the effectiveness of water. These additives operate in a variety of manners to improve fire suppression and/or prevent ignition or re-ignition of fuel. For example, Class A foams, which are commonly used to combat solid-fuel fires, reduce water droplet size to improve the cooling ability of the water to provide fire suppression and also improve the ability of the water to wet the fuel for the fire. Class A foams further act to form a protective blanket over the fuel, thereby insulating the fuel from heat from the fire and oxygen from the air. Class B foams, which are commonly used to combat liquid-fuel fires, are also used to form a protective blanket of the fuel source, preventing flammable vapors from evaporating from the fuel and igniting. Fire-fighting gels, which are commonly used to provide exposure protection, form a barrier to protect adjacent fuels from the heat and flames of a fire and prevent ignition of the adjacent fuels. Other water additives are contemplated herein to enhance the fire-fighting effectiveness of water.

In many implementations, a desired quantity of foaming agent, foam concentrate, or other water additive added to the fire fighting water is held within a tight tolerance. For example, the National Fire Protection Association (NFPA) 1901 Standard for Automotive Fire Apparatus and 1906 Standard for Wildland Fire Apparatus set out accuracy standards for the addition of a foaming agent to fire fighting water. NFPA 1901 and 1906 define various example water additives and specify that for a desired proportioning rate equal or greater than 1%, a 0% to 30% or 1 percentage point (whichever is less) rich actual proportioning rate is in compliance. For desired proportioning rates less than 1%, a 0% to 40% rich proportioning rate is in compliance. Actual proportioning rates lean of the desired proportioning rate are not in compliance because the lack of foam in the fire fighting water may pose a safety hazard to firefighting personnel.

### SUMMARY

Implementations described and claimed herein address the foregoing problems by providing a system comprising a venturi injector having a motive fluid inlet and a suction fluid inlet; and a pressure feedback loop that fluidly links motive fluid pressure at the motive fluid inlet with suction fluid pressure at the suction fluid inlet.

Implementations described and claimed herein address the foregoing problems by further providing a method comprising combining a suction fluid stream at a suction fluid pressure with a motive fluid stream at a motive fluid pressure using a venturi effect; and fluidly linking the motive fluid pressure with the suction fluid pressure.

Other implementations are also described and recited herein.

### BRIEF DESCRIPTIONS OF THE DRAWINGS

FIG. 1 illustrates a schematic for a first example continuous additive proportioning system.

FIG. 2 illustrates a schematic for a second example continuous additive proportioning system.

FIG. 3 illustrates a schematic for a third example continuous additive proportioning system.

FIG. 4 illustrates example operations for operating a continuous additive proportioning system.

FIG. 5 illustrates example operations for operating a calibration circuit for a continuous additive proportioning system.

### DETAILED DESCRIPTIONS

Both manual and automatic proportioning systems may be used to meter additives into a fire fighting water stream. Manual additive proportioners include simple eductors, around-the-pump educting systems, and self-educting nozzles. Eductors include a venturi throat on the fire fighting water line that introduces a negative pressure at the foaming agent inlet, which sucks foam into the water stream. Simple eductors are limited by a large pressure loss on the water stream (e.g., a 35% pressure loss), a narrow operating pressure range (sometimes a singular operating flow rate and operating pressure), and limited accuracy in metering the foaming agent into the water stream. Further, around-the-pump educting systems are limited to a low incoming water stream pressure (e.g., 5 to 15 psig). Further, eductor systems are limited by a narrow operating range in terms of water flow, pressure, and accuracy. Still further, eductor systems cause a significant pressure loss in the water stream.

Automatic proportioners include balanced pressure bladder systems, balanced pressure pump systems, and electronic direct injection systems. The balanced pressure bladder systems operate by using a closed-volume bladder containing the foaming agent. A port from the water stream pressurizes the bladder to a level approximately equal to the incoming water stream pressure. A modified venturi with far less pressure loss than a simple eductor (e.g., a 10% vs. a 35% pressure loss) introduces the foaming agent within the bladder into the water stream. The modified venturi is operable over a greater range of water stream pressures and flow rates. Further, a differential pressure valve (or dynamically adjustable venturi) may be used in place of the modified venturi that operates over an even greater range of water stream pressures and offers improved accuracy. Balanced pressure bladder systems often require that the system be shut down to refill the bladder with concentrate. As a result, balanced pressure bladder systems are limited in their ability to continuously introduce the foaming agent into the continuous stream of water. The flow of foaming agent is stopped while the bladder is refilled with concentrate.

Further, the balanced pressure pump systems may utilize a separate water-driven concentrate pump to move concentrate into the discharge of a modified venturi as discussed above. A port from the water stream operates a balance valve that circulates any output of the concentrate pump exceeding the pressure of the water stream entering the modified venturi back to the pump or the concentrate tank. Balanced pressure pump systems have a limited rate of water flow rates under which they are able to accurately meter the concentrate into the water stream.

Electronic direct injections systems incorporate a flow meter than measures the water stream flow rate. A controller takes the measured water stream flow rate and directs a pump to inject an exact desired rate of foaming agent. One or more constant feedback circuits maintain the desired percentage of foaming agent injected into the water stream. While electronic direct injection systems are very accurate over a very broad range of flow rates and pressures, they are also very expensive.

A cost effective proportioning system that operates accurately over a wide range of water flow rates and pressures, with little to no water pressure loss, and with the capability of refilling the concentrate reservoir during operation would be useful for fighting fires.

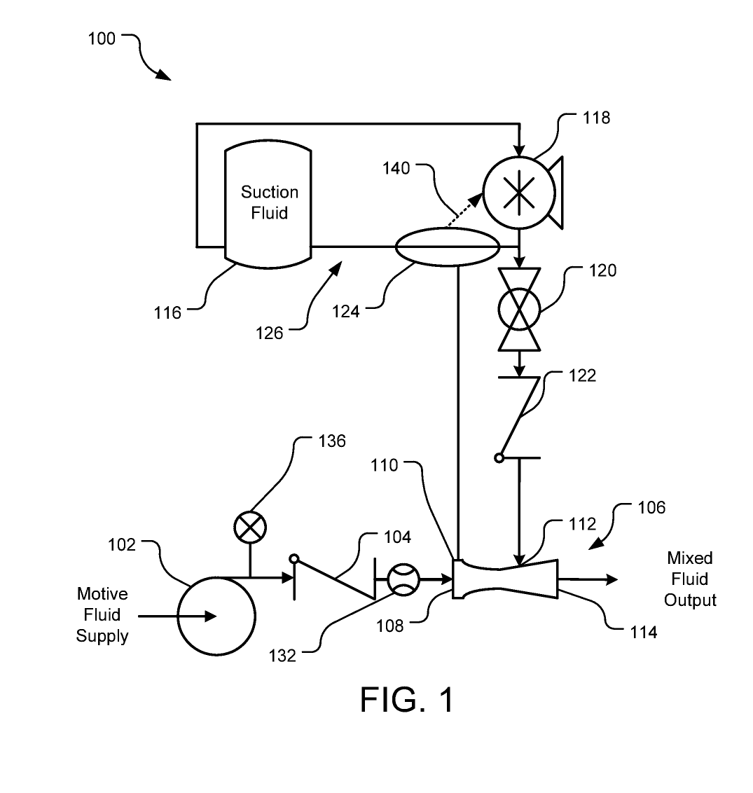

FIG. 1 illustrates a schematic for a first example continuous additive proportioning system 100. A motive fluid supply (e.g., a water supply) enters a motive fluid pump 102 that provides sufficient motive fluid pressure for a variety of flow rates for firefighting and other variable flow rate applications. The pump 102 may be a positive-displacement type (e.g., gear, progressing cavity, roots-type, peristaltic, reciprocating, and compressed air powered double diaphragm), impulse-type (e.g., hydraulic ram), or velocity-type (e.g., centrifugal and eductor-jet), for example. The output of the pump 102 is fed through a motive fluid check valve 104 that prevents the flow direction from reversing back though the output of the pump 102. The check valve 104 may be a ball-type, diaphragm-type, swing-type, stop-check type, lift-check type, or a duckbill-type check valve, for example. In implementations where the motive fluid is supplied at a sufficient pressure (e.g., city water pressure), the pump 102 may be omitted. Further, in other implementations, the check valve 104 is omitted when reversing flow is not expected or likely.

The output of the check valve 104 is fed into a venturi injector 106 (e.g., a eductor or a differential pressure valve). The venturi injector 106 is equipped with an inlet 108, a motive fluid pressure port 110, a suction fluid inlet port 112, and an outlet 114. The motive fluid flows through the inlet 108 into the venturi injector 106 and out of the outlet 114 of the venturi injector 106 after incorporation of a desired quantity of suction fluid (e.g., foam concentrate, gel, or other water additive) as discussed in detail below. Various restrictions within the venturi injector 106 (e.g., one or more spring-loaded disks in the case of a differential pressure valve) cause a pressure differential from the inlet 108 to the outlet 114 to vary proportionally with the motive fluid stream flow rate through the venturi injector 106. For example, the differential pressure under a no-flow condition will be zero. As the motive fluid flow rate increases, so will the differential pressure. The restrictions also cause a venturi throat size and/or location within the venturi injector 106 to dynamically adjust with the motive fluid stream flow rate. The suction fluid may be fed through the inlet port 112 as discussed in detail below and metered into the motive fluid stream at a quantity based on the flow rate of the motive fluid stream.

The system 100 further includes a suction fluid reservoir 116. The reservoir 116 contains a quantity of suction fluid, which in some implementations may be refilled while the system 100 is in operation. A suction fluid pump 118 withdraws suction fluid from the reservoir 116 and provides sufficient suction fluid pressure for a variety of suction fluid flow rates for firefighting and other variable flow rate applications. The pump 118 may be a positive-displacement type, impulse-type, or velocity-type, for example. Further, the pump 118 may be electrically, hydraulically, or mechanically driven, for example. In implementations where the suction fluid is supplied at a sufficient pressure (e.g., head pressure from the reservoir 116), the pump 118 may be omitted.

The pressurized suction fluid output from the pump 118 is fed through a metering valve 120 used to selectively vary the flow rate of the pressurized suction fluid through the valve 120 in order to select and calibrate a suction fluid contribution to the motive fluid stream. The metering valve 120 may further selectively vary a pressure drop through the metering valve 120. The metering valve 120 may be a ball-type, butterfly-type, disc-type, gate-type, globe-type, knife-type, needle-type, pinch-type, piston-type, or a plug-type, for example. In another implementation, the metering valve 120 is not used and an orifice (not shown) of a preselected size is included in the suction fluid stream between the pump 118 and the venturi injector 106. The orifice provides a preselected fixed pressure drop to the suction fluid stream.

The output of the metering valve 120 is fed through a check valve 122 that prevents the flow direction from reversing back though the output of the pump 118. The check valve 122 may be a ball-type, diaphragm-type, swing-type, stop-check type, lift-check type, or a duckbill-type check valve.

The pressurized suction fluid is then fed into the inlet port 112 of the venturi injector 106. The size of the inlet port 112, suction fluid pressure, motive fluid pressure, and flow rate through (and differential pressure across) the venturi injector 106 controls the quantity of suction fluid introduced into the motive fluid stream. The mixed fluid stream discharges from the venturi injector 106 at the outlet 114 for use in various fire-fighting operations.

In an example implementation, the mixed fluid stream may range from about 10 gallons per minute (gpm) to about 125 gpm and from about 50 pounds per square inch (psi) to about 150 psi if the mixed fluid stream output is handled by a user (e.g., via a handheld firefighting lance or nozzle). In an implementation where the mixed fluid stream output is handled remotely (e.g., via a remote operated lance or nozzle), the mixed fluid stream may range from about 60 gpm to about 1000 gpm and from about 125 psi to about 200 psi. Further, the mixed fluid stream pressure and flow rate may vary depending on application (e.g., lower flow rates and pressures for wildfire applications and higher flow rates and pressures for structural and industrial fires).

Additionally, a mixture ratio of suction fluid to motive fluid in the mixed fluid stream may range from about 0.1% to about 6%. In an implementation where the mixed fluid stream is primarily used to extinguish a Class A fire, the mixture ratio may range from about 0.1% to about 1.0%. In an implementation where the mixed fluid stream is primarily used to extinguish a Class B fire, the mixture ratio may range from about 1.0% to about 6.0%, or be specified at about 1%, 3%, or 6%.

Absent bypass circuit 126, the suction fluid pressure would depend on the suction fluid flow rate into the venturi injector 106. However, the bypass circuit 126 returns some, all, or none of the pressurized suction fluid back to the reservoir 116 to maintain a desired suction fluid pressure. A relief valve 124 controls the amount of pressurized suction fluid that returns to the reservoir 116 via the bypass circuit 126. The relief valve 124 varies the flow rate through the bypass circuit 126 so that the pressurized suction fluid upstream of the metering valve 120 is at the same pressure as the motive fluid at the pressure port 110 of the venturi injector 106. The metering valve 120 may add a predetermined pressure drop to the suction fluid.

In one implementation, the pressure port 110 pressurizes a flexible bladder surrounding the bypass circuit 126. If the suction fluid pressure exceeds that of the pressure port 110, the pressurized suction fluid pushes against and through the flexible bladder and back to the reservoir 116. If the suction fluid pressure does not exceed that of the pressure port 110, the bladder pushes against and effectively closes the bypass circuit 126 so that no pressurized suction fluid returns to the reservoir 116. As a result, the suction fluid and the motive fluid pressure are fluidly linked. The suction fluid pressure does not exceed the motive fluid pressure at the pressure port 110 of the venturi injector 106.

Still further, an electric relief valve feedback loop 140 may monitor the state of the relief valve 124 and control the speed of the pump 118 to minimize the opening of the relief valve 124. For example, if the relief valve is consistently open, the feedback loop 140 may slow the pump down. Further, if the relief valve is consistently close, the feedback loop 140 may speed the pump up. This may be done in real time or periodically. In an implementation without the feedback loop 140, a user may manually adjust the pump 118 speed based on the state of the relief valve 124.

Further, the motive fluid supply and/or the mixed fluid output may be equipped with a flow meter 132 that monitors the flow rate of the motive fluid supply and/or the mixed fluid output and alerts a user or automatically stops one or both of the pumps 102, 118 if the motive fluid supply and/or the mixed fluid output flow rate drops below a preset flow rate, which indicates a problem in the system 100. Further yet, the motive fluid supply and/or the mixed fluid output may be equipped with a pressure sensor 136 that monitors the pressure of the motive fluid supply and/or the mixed fluid output and alerts a user or automatically stops one or both of the pumps 102, 118 if the motive fluid supply and/or the mixed fluid output pressure rises above a preset pressure, with indicates a problem in the system 100.

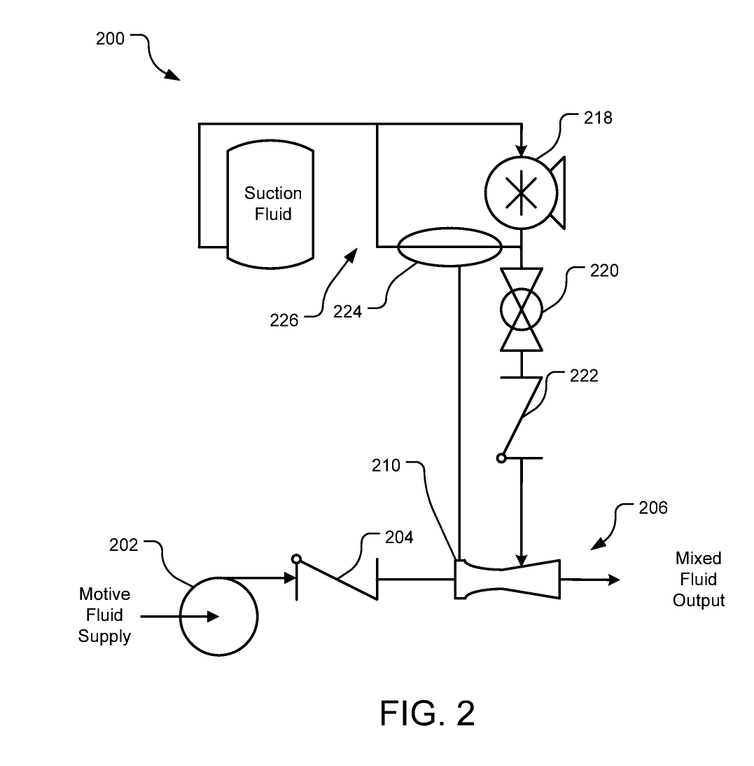

FIG. 2 illustrates a schematic for a second example continuous additive proportioning system 200. The schematic of FIG. 2 is similar to the schematic of FIG. 1 in the operation of pumps 202, 218; check valves 204, 222; venturi injector 206; and metering valve 220. Bypass circuit 226 explicitly differs from the bypass circuit 126 of FIG. 1.

As discussed above, absent bypass circuit 226, the suction fluid pressure would depend on the suction fluid flow (e.g., foam concentrate, gel, or other water additive) rate into the venturi injector 206. The bypass circuit 226 returns some, all, or none of the pressurized suction fluid back to the suction fluid pump 218 (rather than back the reservoir 116 as depicted in FIG. 1) to maintain a desired suction fluid pressure. A relief valve 224 controls the amount of pressurized suction fluid that returns to the pump 218 via the bypass circuit 226. The relief valve 224 varies the flow rate through the bypass circuit 226 so that the suction fluid output from the pump 218 is at the same pressure as the motive fluid pressure at a pressure port 210 of the venturi injector 206.

In one implementation, the pressure port 210 pressurizes a flexible bladder surrounding the bypass circuit 226. If the suction fluid pressure exceeds that of the pressure port 210, the pressurized suction fluid pushes against and through the flexible bladder and back to the pump 218. If the suction fluid pressure does not exceed that of the pressure port 210, the bladder pushes against and effectively closes the bypass circuit 226 so that no pressurized suction fluid returns to the pump 218. As a result, the suction fluid and the motive fluid pressure are fluidly linked. The suction fluid pressure does not exceed the motive fluid pressure at the pressure port 210 of the venturi injector 206.

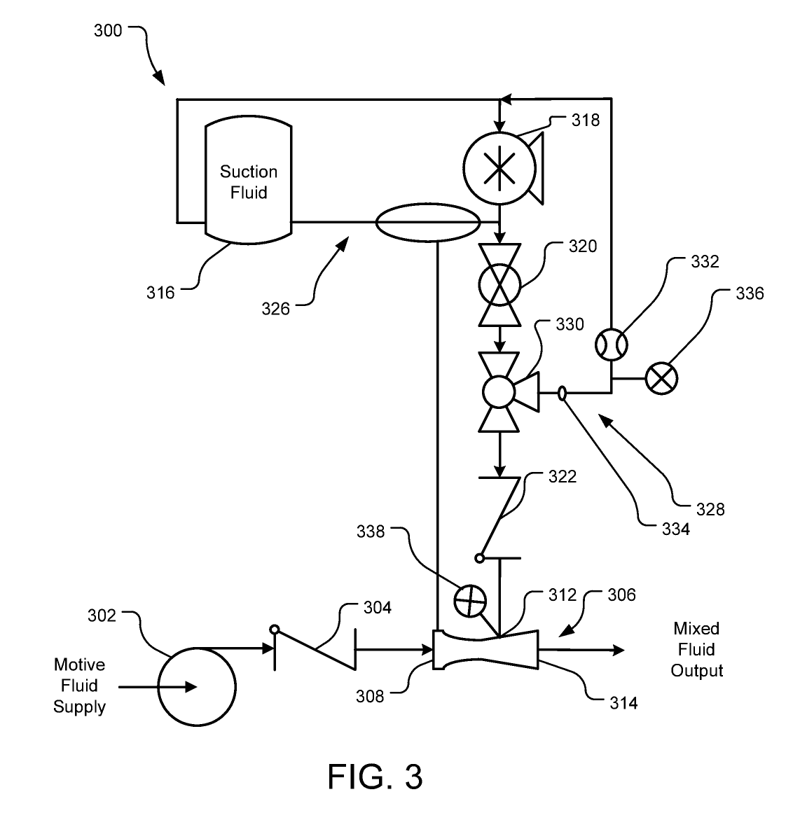

FIG. 3 illustrates a schematic for a third example continuous additive proportioning system 300. The schematic of FIG. 3 is similar to the schematic of FIG. 1 in the operation of pumps 302, 318; check valves 304, 322; venturi injector 306; metering valve 320; and bypass circuit 326. In addition, the schematic of FIG. 3 includes a testing circuit 328.

NFPA 1901 and 1906 standards require that the installer of a foam proportioning system for firefighting purposes calibrate the proportioning system prior to delivery to the customer and after performing maintenance on the proportioning system. It is more accurate to calibrate the foam proportioning system using foam concentrate rather than water alone due to variations in viscosity, density etc. of the foam concentrate as compared to water. However, it is undesirable to consume and waste the foam concentrate due to its high cost and potential environmental impact if not collected and disposed of properly. For example, it can cost upwards of $50,000 of foam concentrate to calibrate a proportioning system for a large industrial application. Further, collection and disposal of the foam concentrate is also quite expensive. Still further, typical foam proportioning systems are time-consuming to calibrate and may require multiple individuals to accurately calibrate. The testing circuit 328 allows a less time-consuming calibration with fewer individuals and allows the foam concentrate utilized for calibration to be reused rather than consumed and wasted.

During calibration of the system 300, 3-way valve 330 is actuated to re-direct the suction fluid (e.g., foam concentrate, gel, or other water additive) from the pump 318 to the testing circuit 328. The testing circuit 328 includes an orifice 334 that approximates the effective orifice size of suction fluid inlet port 312 of the venturi injector 306. Further, the testing circuit 328 includes a flow meter 332 for monitoring the flow rate of the suction fluid from the suction fluid pump 318. The system 300 may be operated over a broad range of motive fluid (e.g., water) stream flow rates as the flow meter 332 is monitored. Metering valve 320 is adjusted so that the flow rate of the suction fluid through the testing circuit 328 is equal to the desired flow rate of the suction fluid into the motive fluid stream flowing through the venturi injector 306 during normal operation. The suction fluid flowing from the pump 318 and through the testing circuit 328 is discharged back to the pump 318 for reuse. In other implementations, the suction fluid flowing through the testing circuit 328 is discharged back into reservoir 316 for reuse.

In a separate implementation, the flow meter 332 is absent from the testing circuit 328 and the suction fluid flowing from the pump 318 and through the testing circuit 328 is discharged into a separate calibration reservoir (not shown). The quantity of suction fluid discharged into the calibration reservoir over a known period of time is measured to determine the flow rate of the suction fluid. After the flow rate of the suction fluid is measured, the collected suction fluid may be reused (e.g., by emptying its contents into the reservoir 316).

Still further, the testing circuit 328 includes a pressure gauge 332 for monitoring the suction fluid pressure in the testing circuit 328. A pressure gauge 338 may also be located at the inlet port 312 of the venturi injector 306. The pressures of the suction fluid flowing through the testing circuit 328 and at the inlet port 312 may be compared to ensure that the suction fluid will flow through the inlet port 312 when the system 300 is in normal operation. In order to accomplish this, the suction fluid flowing through the testing circuit 328 should equal or be at a calibrated pressure slightly below that at the inlet port 312. The pressure gauges 336, 338 may be used to match the pressure in the testing circuit 328 with the pressure at inlet 308 of the venturi injector 306.

After calibration of the system 300 is complete, the 3-way valve 330 is actuated to re-connect the suction fluid supply from the pump 318 to the venturi injector 306 and disconnect the suction fluid supply from the testing circuit 328. The calibrated system 300 may then be operated as described above.

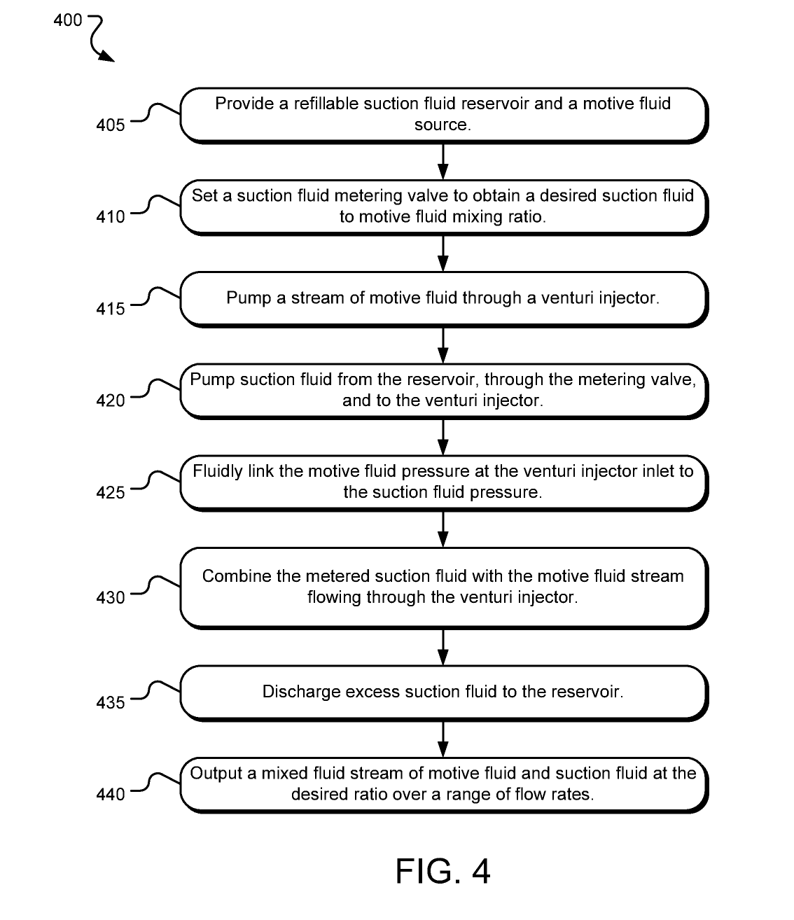

FIG. 4 illustrates example operations 400 for operating a continuous additive proportioning system. A providing operation 405 provides a refillable suction fluid reservoir and a motive fluid source. The suction fluid reservoir stores a volume of suction fluid (e.g., foam concentrate, gel, or other water additive) for addition to a motive fluid stream. The motive fluid source may be sourced from another reservoir or a continuous source (e.g., a city water connection). In one implementation, the suction fluid reservoir may be refilled while operating the continuous additive proportioning system.

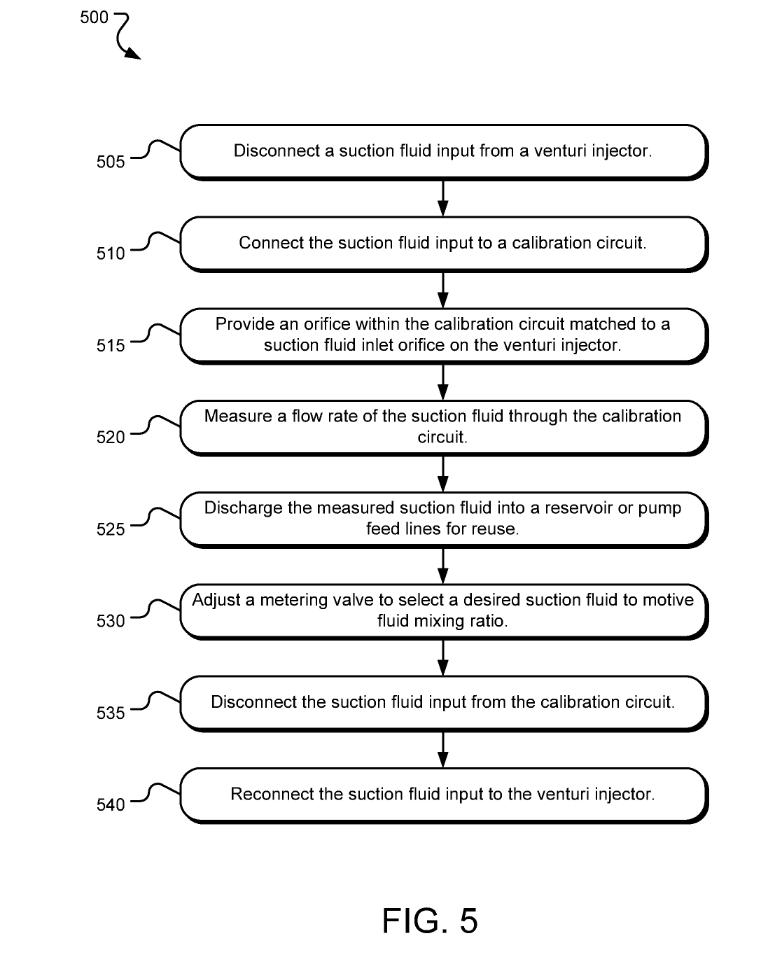

A setting operation 410 sets a suction fluid metering valve to obtain a desired suction fluid to motive fluid mixing ratio. The suction fluid metering valve is adjustable based on a desired suction fluid flow rate and/or a desired pressure drop through the metering valve. Setting operation 410 may be accomplished manually or automatically through an electronic actuator. Further, operations 500 of FIG. 5 describe one implementation of setting operation 410.

A pumping operation 415 pumps a stream of motive fluid through a venturi injector. In one implementation, a motive fluid pump is supplied a low-pressure continuous water supply (e.g., from a city water connection). The motive fluid pump outputs a motive fluid stream with increased pressure so that the suction fluid may be added to the motive fluid stream at a variety of motive fluid flow rates using the venturi injector. A pumping operation 420 pumps suction fluid from the reservoir, through the metering valve, and to the venturi injector. In one implementation, the suction fluid is pumped to an inlet port on the venturi injector for proportional combination with the motive fluid stream.

A fluidly linking operation 425 fluidly links the motive fluid pressure at the venturi injector inlet to the suction fluid pressure. In one implementation, a relief valve is used to vary the flow rate through a bypass circuit so that the pressurized suction fluid upstream of the metering valve is maintained at the same pressure as the motive fluid at a pressure port of the venturi injector. As a result, the suction fluid pressure does not exceed the motive fluid pressure at the pressure port of the venturi injector.

A combining operation 430 combines the metered suction fluid with the motive fluid stream flowing through the venturi injector. In one implementation, the venturi injector includes one or more restrictions that cause a pressure drop through the venturi injector to vary proportionally with the motive fluid stream flow rate through the venturi injector. For example, the differential pressure under a no-flow condition will be zero. As the motive fluid flow rate increases, so will the differential pressure. Further, the restrictions also cause a venturi throat size and/or location within the venturi injector to dynamically adjust with the motive fluid stream flow rate. Since the suction fluid pressure is fluidly linked to the motive fluid pressure at the venturi injector inlet, the suction fluid is combined with the motive fluid stream at a desired ratio, even as the motive fluid stream flow rate (and corresponding pressure drop) through the venturi injector varies.

In one implementation, the flow rate of the motive fluid stream through the venturi injector is proportional to the differential pressure across the venturi injector. As the differential pressure across the venturi injector increases, the difference in pressure between the suction fluid flowing out of the suction fluid pump and the pressure at the inlet port increases. This pressure difference causes a proportional throttling of the suction fluid flow rate through the inlet port on the venturi injector and controls the quantity of pressurized suction fluid introduced into the motive fluid stream.

A discharging operation 435 discharges excess suction fluid to the suction fluid reservoir. The fluidly linking operation 425 may utilize a discharge line back to the reservoir in order to maintain the same pressure as the motive fluid at a pressure port of the venturi injector, as discussed in detail above. If the entire volume of pumped suction fluid is added to the motive fluid stream, none of it is bypassed back to the suction fluid reservoir or back to the suction fluid pump. Otherwise, the discharging operation 435 prevents the metered suction fluid pressure from exceeding the motive fluid supply pressure.

An outputting operation 440 outputs a mixed stream of motive fluid and suction fluid at the desired ratio over a range of flow rates. The output mixed stream may be used for fire-fighting or other purposes.

FIG. 5 illustrates example operations 500 for operating a calibration circuit for a continuous additive proportioning system. A disconnecting operation 505 disconnects a suction fluid (e.g., a foam concentrate, gel, or other water additive) input from a venturi injector for calibration purposes. During normal operation of the continuous proportioning system the suction fluid is input into the venturi injector for metered incorporation into a motive fluid (e.g., water) stream flowing through the venturi injector. A connecting operation 510 connects the suction fluid input to a calibration circuit. Operations 505, 510 may be accomplished using a 3-way valve. A providing operation 515 provides an orifice within the calibration circuit matched to a suction fluid inlet orifice on the venturi injector. The provided orifice may be adjustable or exchangeable to match the suction fluid inlet orifice.

A measuring operation 520 measures a flow rate of the suction fluid through the calibration circuit. In one implementation, the calibration circuit is equipped with a flow meter than directly measures the flow rate through the calibration circuit. In another implementation, a volume of the suction fluid flowing through the calibration circuit is collected over a known period of time. The flow rate of the suction fluid is then calculated by measuring the collected volume and dividing by the amount of time required to collect the volume of suction fluid.

A discharging operation 525 discharges the measured suction fluid into a reservoir or pump lines for reuse. In one implementation, the calibration circuit discharges directly into a line or reservoir that allows the suction fluid to be reused. In another implementation, the collected volume of suction fluid may be emptied into a reservoir or line that allows the suction fluid to be reused.

An adjusting operation 530 adjusts a metering valve to select a desired suction fluid to motive fluid mixing ratio. In one implementation, the measured flow rate is adjusted to a desired flow rate. In another implementation, a measured suction fluid pressure is matched to a measured inlet port pressure on the venturi injector. In various implementations, adjusting operation is performed manually by a technician or via an electronic actuator attached to the metering valve.

A disconnecting operation 535 disconnects the suction fluid input from the calibration circuit. A reconnecting operation 540 reconnects the suction fluid input to the venturi injector. Operations 535, 540 may be accomplished using the 3-way valve used with operations 505, 510. Further, operations 535, 540 are performed when calibration of the continuous proportioning system is complete and prior to commencing normal operation of the continuous proportioning system.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A system comprising:
a venturi injector having a motive fluid inlet and a suction fluid inlet; and
a pressure feedback loop that fluidly links motive fluid pressure at the motive fluid inlet with suction fluid pressure at the suction fluid inlet.

2. The system of claim 1, further comprising:
a relief valve that discharges excess suction fluid responsive to the fluidly linked motive fluid pressure and suction fluid pressure.

3. The system of claim 1, wherein the venturi injector is one of an eductor and a differential pressure valve.

4. The system of claim 1, wherein the venturi injector has a dynamically adjustable throat.

5. The system of claim 1, wherein the venturi injector further has a mixed fluid outlet and is configured to discharge a mixed fluid stream of the motive fluid and the suction fluid with an approximately 0.1% to 6.0% suction fluid to motive fluid mixture ratio.

6. The system of claim 1, further comprising:
a suction fluid metering valve that applies one or both of a selected pressure drop and a selected flow rate to a suction fluid stream upstream of the suction fluid inlet.

7. The system of claim 1, further comprising:
a suction fluid orifice that applies one or both of a selected pressure drop and a selected flow rate to a suction fluid stream upstream of the suction fluid inlet.

8. The system of claim 1, further comprising:
a calibration feedback loop including:
an orifice with a size approximately equal to a suction fluid inlet orifice; and
a flow meter that measures a flow rate of the suction fluid through the calibration feedback loop and discharges the measured suction fluid into a reservoir for reuse.

9. The system of claim 1, wherein the motive fluid is water and the suction fluid is one of a foam concentrate and a gel.

10. A system comprising:
a water pump that provides pressurized water;
an additive reservoir that contains a volume of water additive;
an additive pump that provides pressurized water additive;
a venturi injector having a water inlet and an additive inlet;
a pressure feedback loop that fluidly links the water pressure at the water inlet with the additive pressure at the additive inlet; and
a relief valve that discharges excess additive into the additive reservoir responsive to the fluidly linked water pressure and additive pressure.

11. The system of claim 10, wherein the water pump has a variable speed based on a position of the relief valve.

12. The system of claim 10, wherein the additive reservoir is refillable during operation of the system.

13. The system of claim 10, wherein the additive is one of a foam concentrate and a gel.

14. A method comprising:
combining a suction fluid stream at a suction fluid pressure with a motive fluid stream at a motive fluid pressure using a venturi effect; and
fluidly linking the motive fluid pressure with the suction fluid pressure.

15. The method of claim 14, further comprising:
outputting a mixed fluid stream of the motive fluid and the suction fluid with an approximately 0.1% to 6.0% suction fluid to motive fluid mixture ratio.

16. The method of claim 14, wherein the combining operation draws the suction fluid stream into the motive fluid stream using a venturi effect.

17. The method of claim 14, wherein the combining operation draws the suction fluid stream into the motive fluid stream using a dynamically adjustable throat.

18. The method of claim 14, further comprising:
applying a selected pressure drop to the suction fluid stream upstream of the combining operation.

19. The method of claim 14, further comprising:
restricting the motive fluid stream to a selected flow rate.

20. The method of claim 14, further comprising:
refilling a suction fluid reservoir with suction fluid while performing the combining and fluidly linking operations.

21. The method of claim 14, further comprising:
measuring a flow rate of the suction fluid through a calibration circuit, the calibration circuit having an orifice with a size approximately equal to a suction fluid inlet orifice;
discharging the measured suction fluid into a reservoir for reuse; and
adjusting a suction fluid metering valve to match the measured flow rate through the calibration circuit to a desired suction fluid flow rate combined with the motive fluid stream.

22. The method of claim 14, wherein the motive fluid is water and the suction fluid is one of a foam concentrate and a gel.

23. A method comprising:
pumping a pressurized water stream;
pumping a pressurized additive stream;
combining the additive stream with the water stream using a venturi effect;
fluidly linking the water pressure with the additive pressure; and
discharging excess additive responsive to the fluidly linked water pressure and additive pressure.

24. The method of claim 23, wherein the pumping a pressurized additive stream is performed at a variable rate based on a rate of the discharging operation.

25. The method of claim 23, wherein the additive stream includes one of a foam concentrate and a gel.
